(19) United States
(12) Patent Application Publication
(10) Pub. No.: US 2013/0056539 A1
(43) Pub. Date: Mar. 7, 2013

(54) i-card (biometric and contactless credit and debit cards)

(71) Applicant: Abiodun Daniel Iwaloye, Hamilton Parish (BM)

(72) Inventor: Abiodun Daniel Iwaloye, Hamilton Parish (BM)

(21) Appl. No.: 13/226,704

(22) Filed: Sep. 7, 2011

(51) Int. Cl. G06K 19/073

(52) U.S. Cl. 235/492

(57) ABSTRACT

Contactless credit and debit cards that use biometric sensors for increased security, user authentication and transaction approval and near field communication (“NFC”) technology for the authorisation, approval and processing of transactions through the use of an NFC embedded chip in the credit or debit card, and with an electronic display panel for the card number, outstanding balance or remaining amount and the amount of the current transaction.

### FIELD OF THE INVENTION

The present invention relates to biometric and contactless credit and debit cards providing increased ease and speed of transaction processing for users and also, increased security.

### BACKGROUND OF THE INVENTION

The invention relates to credit and debit cards and more particularly to credit and debit cards that use biometric sensors for user authentication and approval of transactions and with facilities for the use of NFC technology on the credit and debit cards for transaction processing.

In its present state, credit and debit cards do not use NFC technology for transaction processing and do not have biometric sensors for additional security of the user.

It is the objective of the proposed invention for the credit and debit cards to have a biometric sensor that is linked to individual or multiple owners of the credit or debit card and identifies the owner of the credit or debit card as the rightful owner(s) prior to the authentication and approval of the credit or debit card's use in transaction processing.

It is also the objective of the invention for NFC technology to be used in the credit and debit cards so that the credit and debit cards do not necessarily have to be swiped before transactions can be processed. Rather, at the authentication of the credit or debit card through the biometric sensor, payments or data exchange can be made wirelessly to a reader located nearby for example next to a retail cash register, by waving the credit or debit card near or tapping them on the reader.

NFC is a technology already in use in smart phones for simplified transactions, data exchange, and wireless connections between two devices in close proximity to each other, usually by no more than a few centimetres and which is expected to become a widely used system for making payments by smart phones through embedded NFC chips that can send encrypted data a short distance (“near field”) to a reader located nearby. It is the intention of the proposed invention to extend the application of the same technology to actual credit and debit cards through the use of embedded NFC chips in the credit or debit card.

It is further the objective of the proposed invention to have an electronic panel or display for the credit or debit card number and with two additional sections on the display confirming the outstanding or remaining balance on the credit or debit card and the amount for the last/current transaction on the credit or debit card to avoid unnecessary charges to user due to overdrawn amount or exceeded limit and to further avoid being overcharged for transactions.

It is further the objective of the proposed invention for NFC embedded chips and biometric sensors to be used in standard/conventional non electronic credit or debit cards.

### DESCRIPTION OF THE INVENTION

The i-card has all the parts of the existing credit and debit cards with an electronic panel for displaying the card number, additional sub sections on the display for displaying the outstanding balance on the credit card or the remaining amount on the debit card and the amount of current transaction, and either a solar panel or a flat battery to power the device.

As opposed to the standard chip for information storage in current credit and debit cards, the i-card has an embedded NFC chip that is able to transfer encrypted data from the i-card to a reader located near by through a wireless communication means by bringing the card near the reader or tapping the i-card on the reader.

The i-card has a biometric sensor that is pre-programmed to recognise only biometric features peculiar to the owner(s) such as forger prints or other biometric features of the owner and can only be activated by that biometric feature in its use for card activation, and authentication, confirmation or approval of transactions.

The i-card in its use of embedded NFC chips and biometric sensors will be applied to credit and debit cards in its standard/conventional form and in electronic forms.

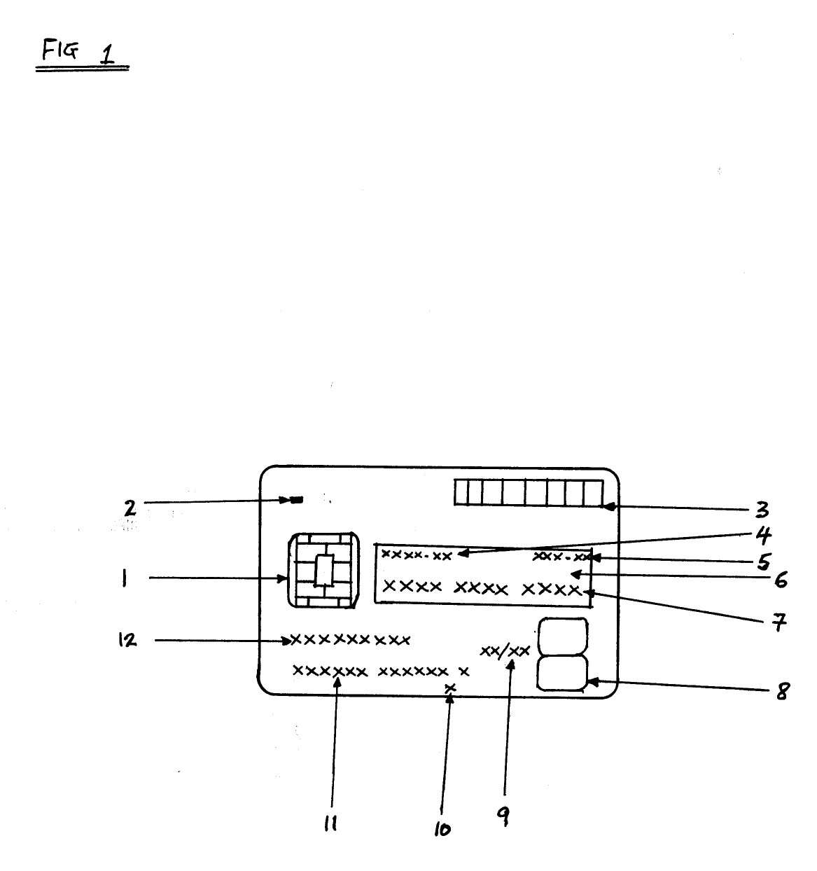

FIG. 1 is a schematic representation of the front view of the electronic version of the i-card in accordance with the present invention. The detailed descriptions are as follows:
1. Embedded NFC chip
2. Wi-Fi button for wireless communication
3. Solar panel or battery to power the invention
4. Outstanding balance or remaining amount
5. Amount of current transaction
6. Electronic display panel for card number, outstanding or remaining balance and current transaction amount
7. Card number
8. Biometric sensor
9. Issue and expiry dates
10. Issue number
11. Card holder's name
12. Account number

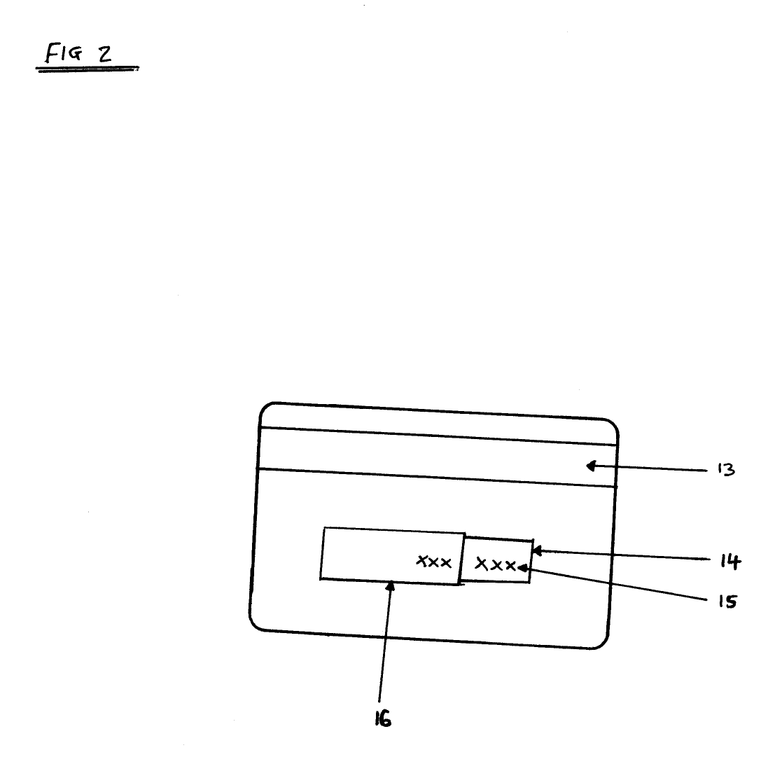

FIG. 2 is a schematic representation of the rear view of the electronic version of the i-card in accordance with the present invention. The detailed descriptions are as follows:
13. Magnetic strip
14. Electronic display panel for CVV
15. CVV
16. Signature panel

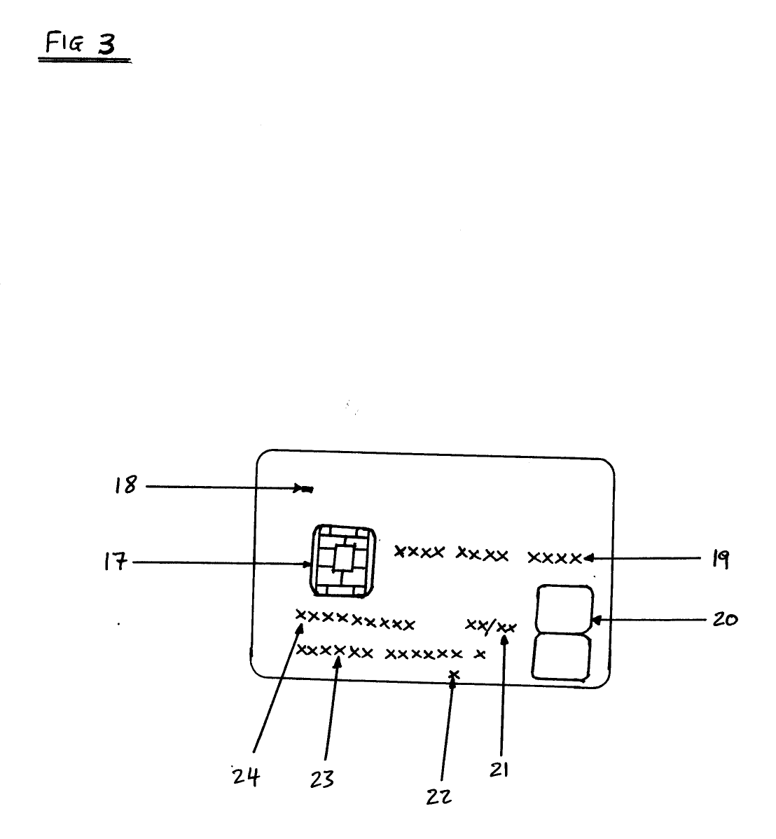

FIG. 3 is a schematic representation of the front view of the standard/conventional version of the i-card in accordance with the present invention. The detailed descriptions are as follows:
17. Embedded NFC chip
18. Wi-Fi button for wireless communication
19. Card number
20. Biometric sensor (optional)
21. Issue and expiry dates
22. Issue number
23. Card holder's name
24. Account number

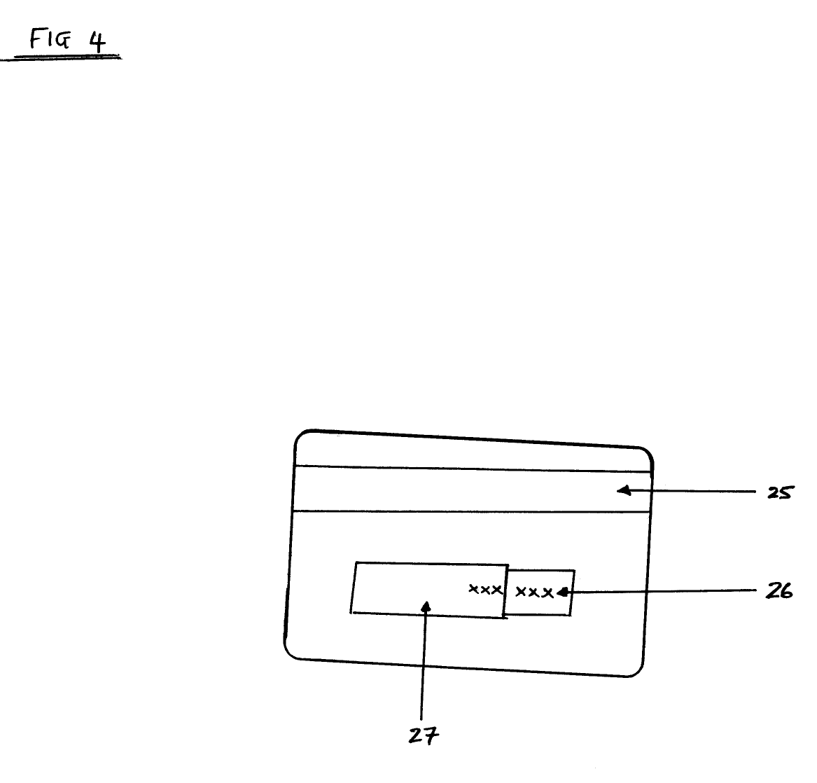

FIG. 4 is a schematic representation of the rear view of the standard version of the i-card in accordance with the present invention. The detailed descriptions are as follows:
25. Magnetic strip
26. CVV
27. Signature panel

What is claimed

1. Whereas the existing types of credit and debit cards do not have biometric sensors, the proposed invention relates to credit and debit cards that have biometric sensors which is used to activate the credit card and which is used to validate the amount of the current transaction before the transaction can be processed.
Whereas the existing types of credit and debit cards do not have embedded NFC chips, the proposed invention relates to credit and debit cards that have embedded NFC chips which allows for simplified transactions processing, data exchange, and wireless connections between the credit or debit card and a reader located nearby, for instance, next to a retail cash register by waving or bringing the credit or debit card near the reader or tapping them on the reader instead of actually swiping the credit or debit card.
Whereas existing credit and debit cards cannot display the outstanding balance on the credit card or the remaining balance on debit card, the proposed invention will have facilities for this to be displayed on an electronic display panel to reduce the chances of the owner going over their credit limit or overdrawing their account balance.
Whereas existing credit and debit cards cannot display the amount of the current transaction to be added to the outstanding balance on the credit card or to be deducted from the remaining balance on debit card, the proposed invention will have facilities for this to be electronically displayed.
It is intended that the i-card will use radio frequency identification (rfid), Wi-fi, bluetooth or other communication technology for communication between the i-card and the reader for the transfer of encrypted data at a short distance between them.
Whereas the existing system makes credit or debit cards prone to fraud as anyone with physical or remote access to the credit card and that can forge the signature of the rightful owner can use the credit or debit card, it is intended by the proposed invention that physical use of the credit or debit card is only possible by biometric authentication.
